(19) United States
(12) Patent Application Publication
(10) Pub. No.: US 2024/0297379 A1
(43) Pub. Date: Sep. 5, 2024

(54) SECONDARY BATTERY

(71) Applicant: MURATA MANUFACTURING CO., LTD., Kyoto (JP)

(72) Inventor: Shuichi NAGAOKA, Kyoto (JP)

(21) Appl. No.: 18/664,708

(22) Filed: May 15, 2024

Related U.S. Application Data
(63) Continuation of application No. PCT/JP2022/047643, filed on Dec. 23, 2022.

(30) Foreign Application Priority Data
Dec. 27, 2021 (JP) 2021-212885

(51) Int. Cl. H01M 50/126; H01M 50/105; H01M 50/186; H01M 50/474; H01M 50/486

(52) U.S. Cl. CPC H01M 50/126; H01M 50/105; H01M 50/186; H01M 50/474; H01M 50/486; H01M 2220/30

(57) ABSTRACT

A secondary battery is provided, the secondary battery including an electrode assembly including at least one electrode constituting layer that is layered and includes a positive electrode, a negative electrode, and a separator, and an exterior body covering the electrode assembly. The secondary battery in which the exterior body includes two exterior sheets including a first exterior sheet and a second exterior sheet, the electrode assembly is disposed between the first exterior sheet and the second exterior sheet, and the first exterior sheet has a larger thickness than the second exterior sheet, the secondary battery having a curved shape in which the first exterior sheet is disposed inside and the second exterior sheet is disposed outside.

### CROSS REFERENCE TO RELATED APPLICATIONS

The present application is a continuation of PCT/JP2022/047643, filed on Dec. 23, 2022, which claims priority to Japanese patent application no. 2021-212885, filed on Dec. 27, 2021, the entire contents of which are incorporated herein by reference.

### BACKGROUND

The present disclosure relates to a secondary battery including a secondary battery provided with an electrode assembly including an electrode constituting layer including a positive electrode, a negative electrode, and a separator.

Secondary batteries are so-called storage batteries and therefore can be repeatedly charged and discharged, and the secondary batteries are used in various applications. For example, secondary batteries are used in mobile devices such as mobile phones, smart phones, and notebook computers.

### SUMMARY

The present disclosure relates to a secondary battery including a secondary battery provided with an electrode assembly including an electrode constituting layer including a positive electrode, a negative electrode, and a separator.

Conventional secondary batteries have problems to be overcome.

For example, WO 2018/037709 A; Japanese Patent Application Laid-Open No. 2020-145200; and Japanese Patent Application Laid-Open No. 2017-33921 disclose a secondary battery having a plate shape. A secondary battery having a plate shape is generally designed to have a certain degree of flexibility so as to be bendable inside an electronic device.

For example, in the secondary battery disclosed in WO 2018/037709 A, a resin layer having a Young's modulus of 3×10⁹ Pa or more is used for forming an exterior body to ensure the flexibility.

In the secondary battery disclosed in Japanese Patent Application Laid-Open No. 2020-145200, a member having rubber elasticity is used as an exterior body, and the member is provided with a protrusion (or a recess) to ensure the flexibility.

In the secondary battery disclosed in Japanese Patent Application Laid-Open No. 2017-33921, the exterior member facing the battery body has a specified coefficient of dynamic friction, or an exterior member including a laminate film is used, and thus the flexibility is ensured.

In the case of using a conventional secondary battery in a wearable device such as a smart watch or a smart ring, for example, a conventional secondary battery 100′ needs to be pressed against and wound around a rod 200′ to curve a body portion 101′ of the battery into a desired shape (see FIGS. 8A and 8B).

In the curved secondary battery 100′, a large number of wrinkles are formed on the inner surface of the curved body portion 101′ (see FIG. 8C), and it has been found that such wrinkles press the inside of the battery and as a result, the inside of the battery may be damaged and destroyed.

Furthermore, although the conventional secondary batteries have a certain degree of flexibility, the flexibility is reversible, and the curved shape is difficult to maintain. It is particularly difficult to maintain the shape of a battery body in a state where the battery body is curved in a ring shape.

The present disclosure has been devised in view of such problems according to an embodiment. The present disclosure relates to providing, in an embodiment, a secondary battery capable of maintaining a curved shape while suppressing formation of a wrinkle generated when the secondary battery is bent.

In an embodiment, the present disclosure provides a secondary battery including:
an electrode assembly including at least one electrode constituting layer that is layered, the at least one electrode constituting layer each including a positive electrode, a negative electrode, and a separator; and
an exterior body covering the electrode assembly,
the exterior body including two exterior sheets including a first exterior sheet and a second exterior sheet,
the electrode assembly disposed between the first exterior sheet and the second exterior sheet,
the first exterior sheet having a thickness larger than a thickness of the second exterior sheet,
the secondary battery having a curved shape in which the first exterior sheet is disposed inside and the second exterior sheet is disposed outside.

In the present disclosure, a secondary battery is obtained that is capable of maintaining a curved shape while suppressing formation of a wrinkle generated when the secondary battery is bent according to an embodiment.

### BRIEF DESCRIPTION OF THE FIGURES

FIG. 1 is a sectional view schematically illustrating a configuration of an electrode assembly.

FIG. 2 is a schematic view schematically illustrating a secondary battery according to an embodiment of the present disclosure.

FIG. 3 is a schematic view schematically illustrating a section of a secondary battery according to an embodiment of the present disclosure.

FIG. 4 is a schematic view schematically illustrating manufacture of a secondary battery according to an embodiment of the present disclosure.

FIG. 5 is a schematic view schematically illustrating manufacture of a secondary battery according to another embodiment of the present disclosure.

FIG. 6A is a schematic view schematically illustrating a section (a section of a portion in which a lead is not installed) of a secondary battery according to another embodiment of the present disclosure.

FIG. 6B is a schematic view schematically illustrating a section (a section of a portion in which a negative electrode lead is installed) of a secondary battery according to another embodiment of the present disclosure.

FIG. 7A is a schematic view schematically illustrating a state before starting a step of bending a secondary battery of the present disclosure.

FIG. 7B is a schematic view schematically illustrating a step of bending a secondary battery of the present disclosure.

FIG. 7C is a schematic view schematically illustrating a step of bending a secondary battery of the present disclosure.

FIG. 7D is a schematic view schematically illustrating a step of bending a secondary battery of the present disclosure.

FIG. 7E is a schematic view schematically illustrating a battery body of a secondary battery of the present disclosure (before a step of bending).

FIG. 8A is a schematic view schematically illustrating a conventional secondary battery in a state before bending.

FIG. 8B is a schematic view schematically illustrating a conventional secondary battery at the time of performing a step of bending.

FIG. 8C is a schematic view schematically illustrating a conventional secondary battery in a state after bending.

### DETAILED DESCRIPTION

The present disclosure will be described in more detail with reference to a secondary battery according to an embodiment of the present disclosure. Although the description will be made with reference to the drawings as necessary, various elements in the drawings are only schematically and exemplarily illustrated for the understanding of the present disclosure, and appearances and/or dimensional ratios may be different from actual ones.

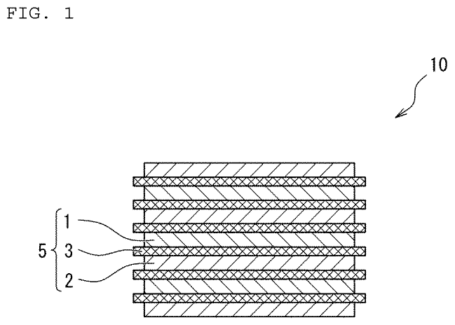

The “sectional view” described directly or indirectly in the present description is basically based on a virtual section obtained by cutting a secondary battery along a layering direction or an overlapping direction of an electrode assembly or an electrode constituting layer included in the secondary battery (see FIG. 1). Similarly, the direction of a “thickness” described directly or indirectly in the present description is basically based on a layering direction of an electrode material included in the secondary battery. For example, in the case of a “plate-like secondary battery having a thickness”, the “thickness” direction corresponds to the plate thickness direction of the secondary battery. A “plan view” or a “plan view shape” used in the present description is based on a sketch drawing in which an object is viewed from the upper side or the lower side along the thickness direction (that is, the layering direction).

A “vertical direction” and a “horizontal direction” used directly or indirectly in the present description correspond to the vertical direction and the horizontal direction in the drawing, respectively. Unless otherwise specified, the same reference symbols or signs indicate the same members or portions or the same semantic contents. In a preferred aspect, when the layering direction of an electrode assembly can correspond to the vertical direction, it can be understood that a vertical downward direction (that is, a direction in which gravity acts) corresponds to the “downward direction” and the opposite direction corresponds to the “upward direction”.

In the present description, the term “secondary battery” refers to a battery that can be repeatedly charged and discharged. Therefore, the secondary battery of the present disclosure is not excessively limited by its name, and for example, power storage devices and the like can also be included in the subject of the present disclosure. Hereinafter, the secondary battery may be referred to as “secondary battery of the present disclosure” or simply as “secondary battery”.

The secondary battery of the present disclosure includes, for example, an electrode assembly including at least one electrode constituting layer that is layered and includes a positive electrode, a negative electrode, and a separator. For example, FIG. 1 schematically illustrates an electrode assembly 10. As illustrated, a positive electrode 1 and a negative electrode 2 may be layered with a separator 3 interposed therebetween to form an electrode constituting layer 5. At least one of such an electrode constituting layer 5 may be layered to form an electrode assembly. FIG. 1 illustrates a planar laminate structure in which the electrode constituting layers 5 are layered in a planar shape.

In the secondary battery, such an electrode assembly may be covered with an exterior body together with an electrolyte (for example, a non-aqueous electrolyte). The structure of the electrode assembly is not necessarily limited to the planar laminate structure. For example, the electrode assembly may have a wound laminate structure. Alternatively, the electrode assembly may have a so-called stacked and folded structure in which the positive electrode, the separator, and the negative electrode are stacked on a long film and then folded.

The positive electrode may include at least a positive electrode material layer and a positive electrode current collector. For the positive electrode, for example, a positive electrode material layer may be provided on at least one surface of a positive electrode current collector. The positive electrode material layer contains a positive electrode active material as an electrode active material. For example, for each of a plurality of positive electrodes in the electrode assembly, the positive electrode material layer may be provided on both surfaces of the positive electrode current collector, or may be provided only on one surface of the positive electrode current collector. For example, the positive electrode current collector may have a foil form. That is, the positive electrode current collector may include a metal foil.

The negative electrode may include at least a negative electrode material layer and a negative electrode current collector. For the negative electrode, for example, a negative electrode material layer may be provided on at least one surface of a negative electrode current collector. The negative electrode material layer contains a negative electrode active material as an electrode active material. For example, for each of a plurality of negative electrodes in the electrode assembly, the negative electrode material layer may be provided on both surfaces of the negative electrode current collector, or may be provided only on one surface of the negative electrode current collector. For example, the negative electrode current collector may have a foil form. That is, the negative electrode current collector may include a metal foil.

The electrode active materials that can be contained in the positive electrode material layer and the negative electrode material layer, that is, the positive electrode active material and the negative electrode active material are materials that can be directly involved in transfer of electrons in the secondary battery, and are respectively main materials of the positive electrode and the negative electrode that are responsible for charge and discharge, that is, a battery reaction.

More specifically, ions can be brought into the electrolyte due to the “positive electrode active material that can be contained in the positive electrode material layer” and the “negative electrode active material that can be contained in the negative electrode material layer”. Such ions move between the positive electrode and the negative electrode to transfer electrons, and charge and discharge are performed.

The positive electrode material layer and the negative electrode material layer may be layers particularly capable of occluding and releasing lithium ions. That is, the secondary battery according to an embodiment of the present disclosure may be a non-aqueous electrolyte secondary battery in which lithium ions move between the positive electrode and the negative electrode with the non-aqueous electrolyte interposed therebetween and thus the battery can be charged and discharged.

In a case where lithium ions are involved in charge and discharge, the secondary battery according to an embodiment of the present disclosure can correspond to a so-called “lithium ion battery”. In the lithium ion battery, the positive electrode and the negative electrode have a layer capable of occluding and releasing lithium ions.

The positive electrode active material in the positive electrode material layer can include, for example, granules, and a binder may be contained in the positive electrode material layer for sufficient contact between the particles and shape retention. A conductive auxiliary agent may be contained in the positive electrode material layer in order to more smoothly transfer electrons promoting the battery reaction.

The negative electrode active material in the negative electrode material layer can include, for example, granules, and a binder may be contained in the negative electrode material layer for sufficient contact between the particles and shape retention. A conductive auxiliary agent may be contained in the negative electrode material layer in order to more smoothly transfer electrons promoting the battery reaction.

The positive electrode material layer and the negative electrode material layer have a form in which a plurality of components are included as described above, and therefore can also be referred to as “positive electrode mixture layer” and “negative electrode mixture layer”, respectively.

The positive electrode active material may be, for example, a material that contributes to occlusion and release of lithium ions. From such a viewpoint, the positive electrode active material may be, for example, a lithium-containing composite oxide. More specifically, the positive electrode active material may be a lithium-transition metal composite oxide containing lithium and at least one transition metal selected from the group consisting of cobalt, nickel, manganese, and iron.

That is, in the positive electrode material layer of the secondary battery according to an embodiment of the present disclosure, such a lithium-transition metal composite oxide may be contained as a positive electrode active material. For example, the positive electrode active material may be lithium cobalt oxide, lithium nickel oxide, lithium manganese oxide, lithium iron phosphate, or a material obtained by replacing the transition metal in such a positive electrode active material with another metal.

Such positive electrode active materials may be contained singly, or in combination of two or more thereof.

The binder that can be contained in the positive electrode material layer is not particularly limited, and examples of the binder include polymer compounds. Specific examples thereof include at least one selected from the group consisting of styrene-butadiene-based rubber, polyacrylic acid, polyimide-based resins, polyamideimide-based resins, polyvinylidene fluoride, a vinylidene fluoride-hexafluoropropylene copolymer, a vinylidene fluoride-tetrafluoroethylene copolymer, polytetrafluoroethylene, and the like.

The conductive auxiliary agent that can be contained in the positive electrode material layer is not particularly limited, and examples of the conductive auxiliary agent include at least one selected from the group consisting of carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, polyphenylene derivatives, and the like.

The thickness dimension of the positive electrode material layer is not particularly limited, and may be 1 μm or more and 300 μm or less, and is, for example, 5 μm or more and 200 μm or less. The thickness dimension of the positive electrode material layer is the thickness inside the secondary battery, and the average of values measured at arbitrary 10 points may be adopted.

The negative electrode active material may be a material that contributes to occlusion and release of lithium ions. From such a viewpoint, examples of the negative electrode active material may include various carbon materials, oxides, and/or lithium alloys, and metallic lithium.

Examples of the various carbon materials as the negative electrode active material include at least one selected from the group consisting of graphite (specifically, natural graphite and/or artificial graphite), hard carbon, soft carbon, and/or diamond-like carbon and the like. In particular, graphite has high electron conductivity, and is, for example, excellent in adhesiveness to a negative electrode current collector.

Examples of the oxides as the negative electrode active material include at least one selected from the group consisting of silicon oxide, tin oxide, indium oxide, zinc oxide, lithium oxide, and the like.

Such an oxide may be amorphous in its structural form. This is because deterioration due to nonuniformity such as a crystal grain boundary or a defect is less likely to be caused.

The lithium alloy as the negative electrode active material may be any alloy of metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, or La.

Such an alloy may be amorphous in its structural form. This is because deterioration due to nonuniformity such as a crystal grain boundary or a defect is less likely to be caused.

The binder that can be contained in the negative electrode material layer is not particularly limited, and examples of the binder include polymer compounds. Specific examples thereof include at least one selected from the group consisting of styrene-butadiene-based rubber, polyacrylic acid, polyimide-based resins, polyamideimide-based resins, polyvinylidene fluoride, a vinylidene fluoride-hexafluoropropylene copolymer, a vinylidene fluoride-tetrafluoroethylene copolymer, polytetrafluoroethylene, and the like.

The conductive auxiliary agent that can be contained in the negative electrode material layer is not particularly limited, and examples of the conductive auxiliary agent include at least one selected from the group consisting of carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, polyphenylene derivatives, and the like.

The thickness dimension of the negative electrode material layer is not particularly limited, and may be 1 μm or more and 300 μm or less, and is, for example, 5 μm or more and 200 μm or less. The thickness dimension of the negative electrode material layer is the thickness inside the secondary battery, and the average of values measured at arbitrary 10 points may be adopted.

The positive electrode current collector and the negative electrode current collector that can be used in the positive electrode and the negative electrode are members capable of collecting and supplying electrons generated in the electrode active material due to the battery reaction. Such an electrode current collector may be a sheet-like metal member. Such an electrode current collector may have a porous or perforated form. For example, the current collector may be a plate, a metal foil, a punching metal, a net, an expanded metal, or the like.

The positive electrode current collector that can be used in the positive electrode may include a metal foil containing at least one selected from the group consisting of aluminum, stainless steel (SUS), nickel, and the like. The positive electrode current collector may be, for example, an aluminum foil.

The negative electrode current collector that can be used in the negative electrode may include a metal foil containing at least one selected from the group consisting of copper, stainless steel (SUS), nickel, and the like. The negative electrode current collector may be, for example, a copper foil.

In the present disclosure, “stainless steel” (SUS) refers to, for example, stainless steel specified in “JIS G 0203 Glossary of terms used in iron and steel”, and may be alloy steel containing chromium or containing chromium and nickel.

The thickness dimension of each of the positive electrode current collector and the negative electrode current collector is not particularly limited, and may be 1 μm or more and 100 μm or less, and is, for example, 10 μm or more and 70 μm or less. The thickness dimension of each of the positive electrode current collector and the negative electrode current collector is the thickness inside the secondary battery, and the average of values measured at arbitrary 10 points may be adopted.

The separator that can be used in the positive electrode and the negative electrode is a member that can be provided from the viewpoint of, for example, preventing a short circuit due to contact between the positive electrode and the negative electrode, and holding the electrolyte. In other words, it can be said that the separator is a member that can allow ions to pass through while preventing electronic contact between the positive electrode and the negative electrode.

For example, the separator may be a porous or microporous insulating member, and have a membrane form due to its small thickness. A microporous membrane made of a polyolefin may be used as the separator, although merely an example.

The microporous membrane that can be used as the separator may contain, for example, only polyethylene (PE) or only polypropylene (PP) as a polyolefin. Furthermore, the separator may be a laminate that can include a “microporous membrane made of PE” and a “microporous membrane made of PP”. The surface of the separator may be covered with an inorganic particle coating layer and/or an adhesive layer and the like. The surface of the separator may have adhesiveness.

The thickness dimension of the separator is not particularly limited, and may be 1 μm or more and 100 μm or less, and is, for example, 2 μm or more and 30 μm or less. The thickness dimension of the separator is the thickness inside the secondary battery (particularly, the thickness between the positive electrode and the negative electrode), and the average of values measured at arbitrary 10 points may be adopted.

In the present disclosure, the separator is not to be particularly limited by its name, and may be a solid electrolyte, a gel-like electrolyte, and/or insulating inorganic particles and the like that can have a similar function.

In the secondary battery according to an embodiment of the present disclosure, for example, the electrode assembly including at least one electrode constituting layer that is layered and includes a positive electrode, a negative electrode, and a separator may be covered with an exterior body together with an electrolyte. The electrolyte can assist movement of metal ions released from the electrodes (the positive electrode and/or the negative electrode). The electrolyte may be, for example, a “non-aqueous” electrolyte containing a non-aqueous or organic electrolyte and/or a solvent and the like, or may be an “aqueous” electrolyte containing water.

In a case where the positive electrode and the negative electrode have, for example, a layer capable of occluding and releasing lithium ions, the electrolyte may be a lithium ion-containing electrolyte or a “non-aqueous” electrolyte (hereinafter, referred to as a “non-aqueous electrolyte”) containing a non-aqueous or organic electrolyte and/or a solvent and the like. That is, the electrolyte may be a non-aqueous electrolyte. In the electrolyte, metal ions released from the electrodes (the positive electrode and/or the negative electrode) are present, and therefore the electrolyte can assist movement of metal ions in the battery reaction.

The secondary battery according to an embodiment of the present disclosure may be a non-aqueous electrolyte secondary battery in which a “non-aqueous” electrolyte is used that contains a “non-aqueous” solvent and a solute as an electrolyte. The electrolyte may have a form such as a liquid form or a gel form (in the present description, the “liquid” non-aqueous electrolyte is also referred to as “non-aqueous electrolyte solution”).

The non-aqueous electrolyte may be an electrolyte containing a non-aqueous solvent and a solute. A specific solvent of the non-aqueous electrolyte may contain at least a carbonate. The carbonate may be a cyclic carbonate and/or a chain carbonate.

Although not particularly limited, examples of the cyclic carbonate include at least one selected from the group consisting of propylene carbonate (PC), ethylene carbonate (EC), butylene carbonate (BC), and vinylene carbonate (VC).

Examples of the chain carbonate include at least one selected from the group consisting of dimethyl carbonate (DMC), diethyl carbonate (DEC), ethyl methyl carbonate (EMC), and dipropyl carbonate (DPC).

In one preferred embodiment of the present disclosure, a combination of a cyclic carbonate and a chain carbonate may be used as the non-aqueous electrolyte, and for example, a mixture of ethylene carbonate (EC) and diethyl carbonate (DEC), a mixture of ethylene carbonate (EC) and ethyl methyl carbonate (EMC), or the like may be used, although merely an example. As a specific solute of the non-aqueous electrolyte, for example, a Li salt such as LiPF₆ and/or LiBF₄ may be used.

In the present disclosure, the “exterior body” of the secondary battery generally means a member capable of covering the electrode assembly in which at least one electrode constituting layer including a positive electrode, a negative electrode, and a separator is layered. The exterior body may include an exterior body having electrical conductivity or conductivity. Alternatively, the exterior body may include a laminate film or the like.

In the present disclosure, the term “lead” means a conductive member that can be electrically connected to the positive electrode and/or the negative electrode of the electrode assembly, and can protrude or extend from the electrode assembly.

Such a lead may extend from the “positive electrode current collector” and/or the “negative electrode current collector” described above, and the lead and the current collector may include the same material and may be formed integrally.

In the present disclosure, the above-described configuration may be appropriately changed or modified as necessary. Alternatively, another member produced separately may be used.

The secondary battery of the present disclosure is described below in further detail according to an embodiment.

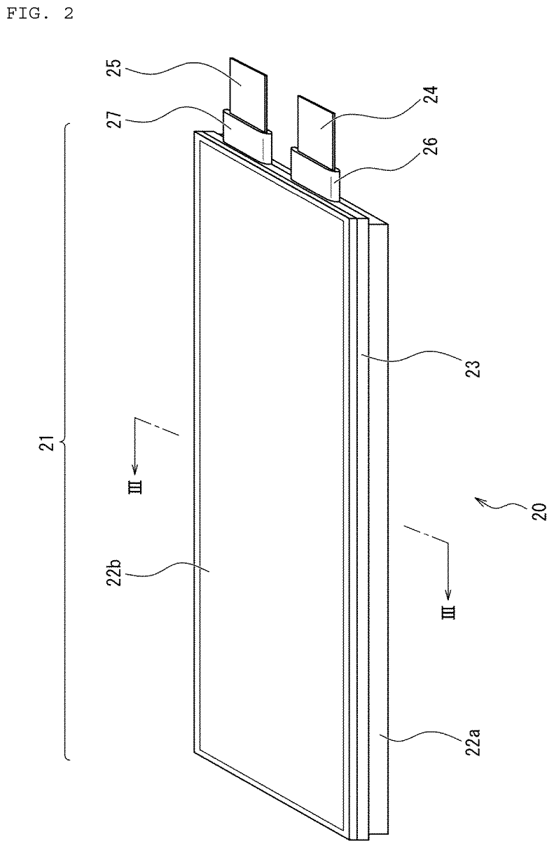

For example, if two exterior sheets (22a, 22b) having different thicknesses are disposed as exterior bodies (see FIG. 2) on the surface of a plate-like electrode assembly having a laminate structure including at least one electrode constituting layer (5) that is layered and includes a positive electrode (1), a negative electrode (2), and a separator (3) as illustrated in FIG. 1, when the battery body is largely curved, the difference in thickness in the battery body can suppress formation of a wrinkle.

According to an embodiment, if the inner sheet has a larger thickness than the outer sheet, formation of a wrinkle on the inner sheet can be significantly suppressed.

The present disclosure provides a secondary battery including an electrode assembly including at least one electrode constituting layer that is layered and includes a positive electrode, a negative electrode, and a separator, and an exterior body covering the electrode assembly. In the secondary battery, the exterior body includes two exterior sheets including a first exterior sheet and a second exterior sheet, the electrode assembly is disposed between the first exterior sheet and the second exterior sheet, and the first exterior sheet has a larger thickness than the second exterior sheet, and the secondary battery has a curved shape in which the first exterior sheet is disposed inside and the second exterior sheet is disposed outside.

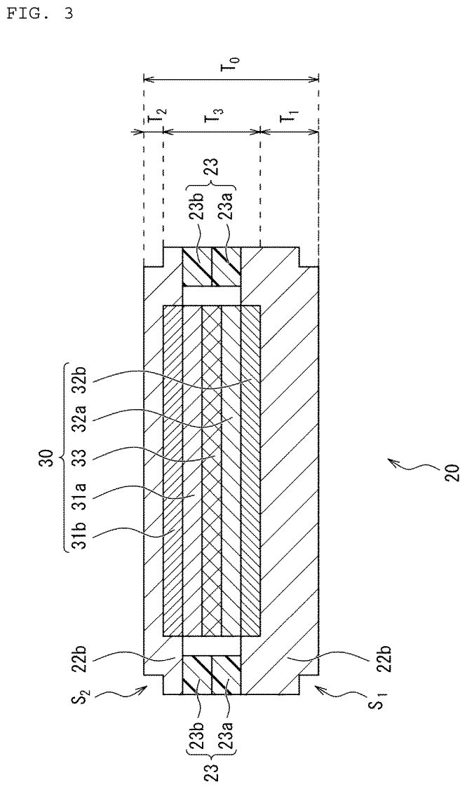

For example, as illustrated in FIG. 2, a secondary battery 20 according to an embodiment of the present disclosure has a battery body 21. The battery body 21 includes an exterior body 22 that covers an electrode assembly (not shown). In the exemplary form illustrated in FIG. 2, the exterior body 22 may include two exterior sheets including a first exterior sheet 22a and a second exterior sheet 22b. The electrode assembly may be positioned between the first exterior sheet 22a and the second exterior sheet 22b (see FIGS. 3 and 4).

In the form illustrated in FIG. 2, for example, a resin member 23 may be disposed between the first exterior sheet 22a and the second exterior sheet 22b so as to cover the peripheral edge of the electrode assembly. The resin member 23 may be divided into two or more layers as described in detail below.

In the present disclosure, the “peripheral edge of the electrode assembly” generally means a portion excluding a main surface of the electrode assembly. For example, in the case of an electrode assembly having a plate shape having two main surfaces, the peripheral edge of the electrode assembly means a surface excluding the two main surfaces.

In the form illustrated in FIG. 2, two leads, specifically, a first lead 24 and a second lead 25 may extend from the battery body 21, particularly, from the resin member 23. One of the first lead 24 and the second lead 25 may be a positive electrode lead, and the other may be a negative electrode lead. For convenience of description, the first lead 24 will be described as a positive electrode lead, and the second lead 25 will be described as a negative electrode lead, but any of them may be a positive electrode or a negative electrode. The positions where the first lead 24 and the second lead 25 extend are not particularly limited, and only the first lead 24 or the second lead 25 may extend.

The first lead 24 and/or the second lead 25 may be covered with a sealant 26 and/or 27 having an insulating property, respectively, as necessary. A portion in which the electrode lead is in contact with the resin member 23 is preferably covered with the sealant.

For convenience of description, the secondary battery 20, particularly the battery body 21, is shown in a form having a plate shape, preferably a band shape, but the shape of the battery body 21 is not limited to a plate shape or a band shape.

If the secondary battery 20, particularly the battery body 21, has a plate shape, preferably a band shape, the battery body 21 can be more easily curved without a wrinkle.

FIG. 3 schematically illustrates a section taken along the line III-III of the battery body 21 illustrated in FIG. 2.

As schematically illustrated in the sectional view of FIG. 3, in the secondary battery 20 of the present disclosure, the thickness (T₁) of the first exterior sheet (22a) is larger than the thickness (T₂) of the second exterior sheet (22b) (T₁>T₂).

The thickness (T₁) of the first exterior sheet (22a) and the thickness (T₂) of the second exterior sheet (22b) each generally mean the largest thickness in the portion covering the electrode assembly (see FIG. 3).

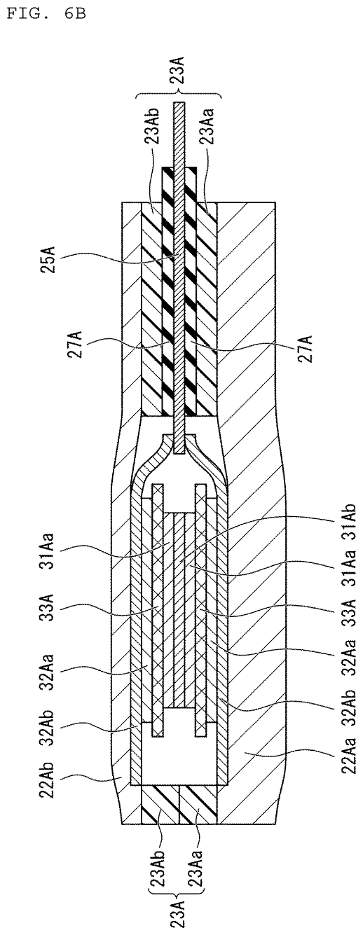

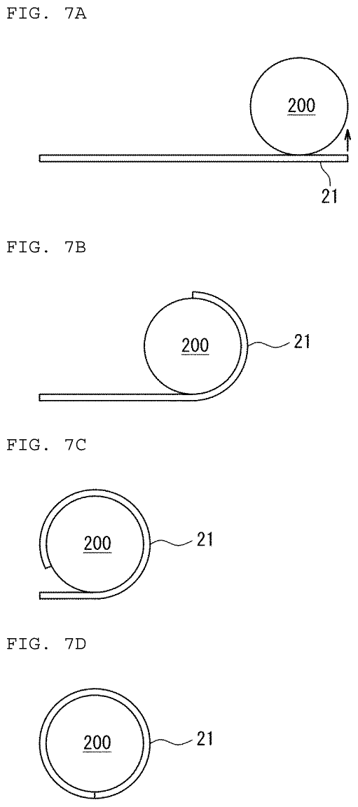

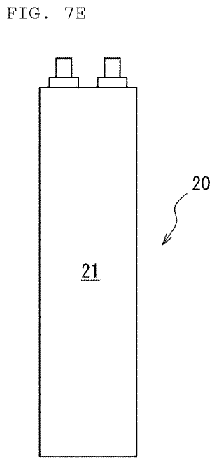

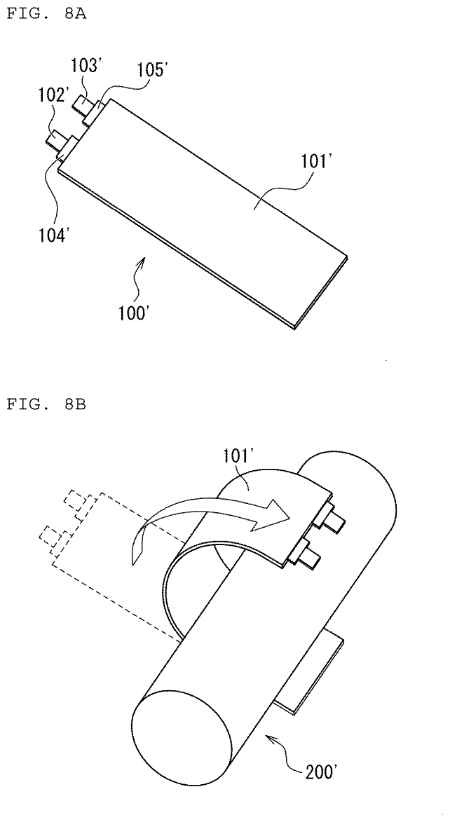

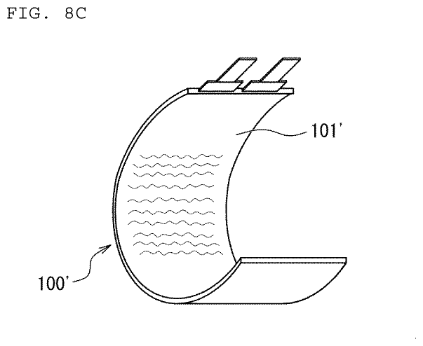

For example, as schematically illustrated in FIGS. 7A to 7E, the battery body 21 of the secondary battery 20 of the present disclosure (see FIG. 7E) is wound around a rod 200 by applying a force in the direction of the arrow as illustrated in FIG. 7A, and thus the battery body 21 can be bent to have a substantially circular shape, preferably a perfect circle shape (see FIGS. 7A to 7D).

As described above, the secondary battery 20 of the present disclosure has a curved shape in which the first exterior sheet 22a having the above-described configuration is disposed inside and the second exterior sheet 22b having the above-described configuration is disposed outside. As a result, when the secondary battery 20, particularly the battery body 21, is bent so that the first exterior sheet 22a of the secondary battery 20 is inside and the second exterior sheet 22b is outside, the curved shape of the battery body 21 can be maintained, and a wrinkle that can be generated in the first exterior sheet 22a can be significantly suppressed.

In the present disclosure, the phrase “a wrinkle can be significantly suppressed” means, in a broad sense, that formation of a wrinkle or distortion cannot be visually confirmed, and in a narrow sense, means that a flat or smooth surface having a height of 0.01 μm or more and 30 μm or less, preferably 10 μm or less without irregularities is obtained. The irregularities can be confirmed with a means such as a laser interference type thickness meter.

Without being bound by a specific theory, in the secondary battery of the present disclosure, the first exterior sheet has a larger thickness than the second exterior sheet, and thus a wrinkle that can be generated in the first exterior sheet (inner surface) can be significantly suppressed. Such an effect is unprecedented, heterogeneous, and unique. It is considered that this effect is obtained, when the battery body is bent and deformed, by moving the neutral point of deformation toward the first exterior sheet. Conventionally, it has been considered that wrinkles increase when the thickness is increased, and thus, the effect of reducing wrinkles by increasing the thickness is wholly unexpected and remarkable.

For example, as schematically illustrated in FIG. 3, the ratio (T₁/T₂) of the thickness (T₁) of the first exterior sheet 22a/the thickness (T₂) of the second exterior sheet 22b (that is, the ratio of the thickness (T₁) of the first exterior sheet 22a to the thickness (T₂) of the second exterior sheet 22b) is, for example, 1.1 or more and 25 or less, preferably 1.7 or more and 25 or less, and more preferably 3.0 or more and 10 or less. Within the above-described range, the curved shape can be maintained, and a wrinkle that can be generated on the surface of the first exterior sheet 22a can be significantly suppressed.

The difference (T₁-T₂) between the thickness (T₁) of the first exterior sheet 22a and the thickness (T₂) of the second exterior sheet 22b is, for example, 10 μm or more and 240 μm or less, and preferably 20 μm or more and 90 μm or less. Within the above-described range, the curved shape can be maintained, and a wrinkle that can be generated on the surface of the first exterior sheet 22a can be significantly suppressed.

The thickness (T₁) of the first exterior sheet 22a is generally 300 μm or less, for example, 25 μm or more and 250 μm or less.

The thickness (T₂) of the second exterior sheet 22b is generally 300 μm or less, for example, 10 μm or more and 240 μm or less.

The total thickness (T₃) of an electrode assembly 30 is, for example, 0.100 mm or more and 2.50 mm or less. The total thickness (T₃) of the electrode assembly 30 generally means the thickness of the portion having the largest thickness in a section of the electrode assembly 30 (see FIG. 3).

The thickness (T₀) of the battery body is, for example, 0.150 mm or more and 3.000 mm or less.

The thickness (T₀) of the battery body generally means the thickness of the portion having the largest thickness in a section of the battery body (see FIG. 3).

For example, as schematically illustrated in FIG. 7D, the radius of curvature when the secondary battery 20 of the present disclosure, particularly the body portion 21, is bent is, for example, 5 mm or more, preferably 5 mm or more and 20 mm or less, and more preferably 6.5 mm or more and 20 mm or less. Also in the case of such a radius of curvature, the curved shape can be maintained, and a wrinkle that can be generated on the surface of the first exterior sheet 22a can be significantly suppressed.

The “radius of curvature” of the secondary battery 20, particularly the battery body 21, can be determined, for example, from the radius of the rod 200 having a circular sectional shape (see FIG. 7D).

As described above, the secondary battery of the present disclosure has a curved shape, and thus the shape can be maintained. The secondary battery having a curved shape may have, for example, a curved shape constituting at least a part of a virtual circle in a sectional view in the layering direction, preferably in a section in the layering direction along the longitudinal direction of the body portion. In other words, the curved shape means a shape in which at least a part of the body portion is bent, and may be, for example, a circular shape as illustrated in FIG. 7D or a part of a circle (for example, a shape like a letter C).

With such a curved shape, the secondary battery of the present disclosure can be more easily disposed inside a structure having a ring shape such as a bracelet or a ring.

In the present disclosure, the “virtual circle” means, for example, a circle that can be formed using a section of the rod 200 as illustrated in FIGS. 7A to 7D.

The secondary battery of the present disclosure can maintain a curved shape and significantly suppress a wrinkle that can be generated on the surface of the curved body portion, and can thus prevent damage to the inside of the battery (electrode assembly). Therefore, the secondary battery can be more appropriately used as a battery for a wearable device such as a smart watch, a smart ring, or smart glasses.

Hereinafter, the configuration and the manufacturing method of the secondary battery of the present disclosure will be described in detail with reference to FIG. 4, but the secondary battery of the present disclosure is not limited to the illustrated form.

For example, as schematically illustrated in FIG. 4, an electrode assembly 30 may be, for example, an electrode assembly including an electrode constituting layer including a positive electrode 31, a negative electrode 32, and a separator 33. The illustrated form is merely for the purpose of showing an example, and the number of positive electrodes, negative electrodes, and separators can be appropriately changed as necessary. The positive electrode 31 may be changed to a negative electrode, and the negative electrode 32 may be changed to a positive electrode.

The positive electrode 31 includes a positive electrode material layer 31a and a positive electrode current collector 31b. The positive electrode material layer 31a may be disposed so as to face the separator 33.

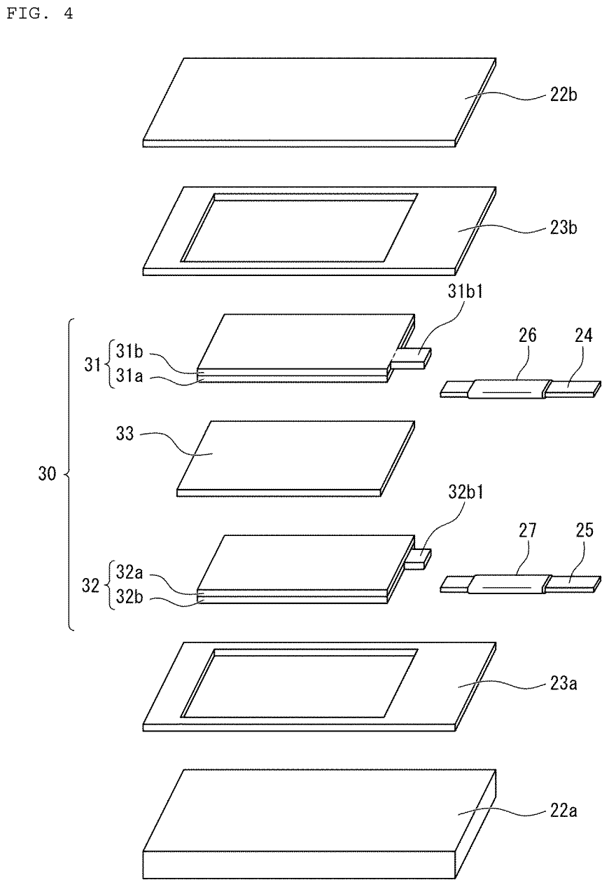

The configuration of the positive electrode is not limited to the illustrated form, and the number and the arrangement of positive electrode material layers 31Aa and positive electrode current collectors 31Ab can be appropriately changed as necessary (see FIG. 5).

Specifically, in the aspects illustrated in FIGS. 4 and 5, first leads 24 and 24A may extend from positive electrode tabs 31b1 and 31Ab1 positioned at the ends of the positive electrode current collectors 31b and 31Ab, respectively. The first leads 24 and 24A may include the same material as the positive electrode current collectors 31b and 31Ab, or may include another conductive material. As necessary, at least a part of the first lead 24 and at least a part of the first lead 24A may be covered or protected with sealants 26 and 26A having an insulating property, respectively. In particular, the peripheries of the boundaries of the portions where the first leads 24 and 24A protrude from the battery bodies may be covered or protected with the sealants 26 and 26A, respectively. In FIG. 5, capital letter A is added to the reference symbols of the components corresponding to the components illustrated in FIG. 4.

The negative electrode 32 includes a negative electrode material layer 32a and a negative electrode current collector 32b. The negative electrode material layer 32a may be disposed so as to face the separator 33. The configuration of the negative electrode is not limited to the illustrated form, and the number and the arrangement of negative electrode material layers 32Aa and negative electrode current collectors 32Ab can be appropriately changed as necessary (see FIG. 5).

Specifically, in the aspect illustrated in FIG. 4, a second lead 25 may extend from a tab 32b1 positioned at the end of the negative electrode current collector 32b. In the aspect illustrated in FIG. 5, the second lead 25A may extend from a portion disposed so as to be sandwiched between a negative electrode tab 32Ab1 positioned at the end of the negative electrode current collector 32Ab and a negative electrode tab 32Ab1 positioned at the end of the negative electrode current collector 32Ab. The second leads 25 and 25A may include the same material as the negative electrode current collectors 32b and 32Ab, or may include another conductive material. As necessary, at least a part of the second lead 25 and at least a part of the second lead 25A may be covered or protected with sealants 27 and 27A having an insulating property, respectively. In particular, the peripheries of the boundaries of the portions where the second leads 25 and 25A protrude from the battery bodies may be covered or protected with the sealants 27 and 27A, respectively.

The electrode assembly 30 including the positive electrode 31, the negative electrode 32, and the separator 33 is preferably produced in advance in accordance with a conventionally known method.

Two exterior sheets (the first exterior sheet 22a and the second exterior sheet 22b) can be disposed as an exterior body in the electrode assembly 30.

More specifically, the first exterior sheet 22a may be disposed so as to face the negative electrode current collector 32b, and the second exterior sheet 22b may be disposed so as to face the positive electrode current collector 31b (see FIGS. 3 and 4).

In such a configuration, the electrode assembly 30 can be positioned between the first exterior sheet 22a and the second exterior sheet 22b (FIG. 3).

At the peripheral edge of the electrode assembly 30, for example, a resin member including two resin sheets (specifically, a first resin sheet 23a and a second resin sheet 23b) may be disposed (see FIGS. 3 and 4). In the case of such a disposition, for example, as illustrated in FIGS. 3, 4, and the like, the resin member 23 including two resin sheets of the resin sheets 23a and 23b can be interposed between the exterior sheets. In the case of an exterior sheet including a laminate film, the innermost layer includes an adhesive layer having an adhesive function as described below, and therefore the “resin sheet” may be an inessential component in the present disclosure.

Each of the first resin sheet 23a and the second resin sheet 23b may be provided with an opening (preferably, an opening having the same shape and the same dimension), and the electrode assembly 30 can be positioned inside such an opening. Such an opening is inessential.

The first resin sheet 23a and the second resin sheet 23b preferably have an insulating property and a heat sealing property, and the first resin sheet 23a and the second resin sheet 23b may be bonded to each other by heat sealing. Furthermore, the first resin sheet 23a and the first exterior sheet 22a may be bonded to each other by heat sealing, and the second resin sheet 23b and the second exterior sheet 22b may be bonded to each other by heat sealing.

Such bonding by heat sealing can be achieved by disposing the electrode assembly 30, the resin member 23 (specifically, the first resin sheet 23a and the second resin sheet 23b), and the exterior body 22 (specifically, the first exterior sheet 22a and the second exterior sheet 22b) at appropriate positions, and then applying heat and pressure to the peripheral edge of the battery body 21. Steps (S1, S2) can be formed at the edge of the surface of the exterior body 22 (specifically, the first exterior sheet 22a and the first exterior sheet 22b) by such heat sealing (see FIG. 3), but such a step is not an essential component of the present technology, and may be present or absent.

In the secondary battery 20 of the present disclosure manufactured as described herein, the body portion 21 can be bent and curved, and thereafter, the curved shape can be maintained. In other words, the present technology can provide a curved cell or a curved battery according to an embodiment.

For example, the battery body 21 is wound around the rod 200 by applying a force in the direction of the arrow as illustrated in FIG. 7A, and thus the battery body 21 can be curved to have a circular shape (see FIGS. 7A to 7D). Although not particularly limited, the longitudinal dimension of the battery body 21 wound around the rod 200 may be longer than the circumferential length of the rod 200. In this case, the battery body 21 can be wound around the rod 200 by one turn or more. The longitudinal dimension of the battery body 21 wound around the rod 200 is preferably equal to or less than the circumferential length of the rod 200, and more preferably equal to or more than half of the circumferential length of the rod 200 and equal to or less than the circumferential length of the rod 200.

The applied force and the bending time are not particularly limited, but, for example, a force of 5 N or more and 300 N or less is preferably applied, for example, for 1 second or more and 30 seconds or less. Under such conditions, the curved shape of the battery body can be maintained, and a wrinkle that can be generated on the inner surface of the exterior body can be significantly suppressed.

The battery body 21 is curved at a pressure of, for example, 1.0 to 20.0 MPa, preferably 1.0 to 10.0 MPa.

The battery body 21 is wound around the rod 200 as illustrated in FIGS. 7A to 7D at a speed of, for example, 1 to 20 mm/sec, preferably 1 to 10 mm/sec.

Under such conditions of the pressure and/or the speed, the curved shape of the battery body can be maintained, and a wrinkle that can be generated on the inner surface of the exterior body can be significantly suppressed. Note that if the effective battery width (the battery width in contact with the rod) is changed, the force and the pressure applied at the time of curving also need to be changed.

Hereinafter, the “exterior body”, the “resin member”, the “lead”, and the “sealant” will be described in detail.

The exterior body is, for example, a component or a member that can be disposed so as to face two main surfaces of the electrode assembly, and generally has a plate shape, preferably a sheet shape.

For example, as illustrated in FIG. 4, the exterior body may include, for example, two exterior sheets, for example, the first exterior sheet 22a and the second exterior sheet 22b. For convenience of description, the sheet having a larger thickness is referred to as “first exterior sheet”, and the sheet having a smaller thickness is referred to as “second exterior sheet”.

The shapes of the first exterior sheet and the second exterior sheet in a top view are not particularly limited, and may be a rectangular shape as in the illustrated form or any other geometric shape other than the rectangular shape.

The first exterior sheet and the second exterior sheet may each independently include a metal plate, a clad material, or a laminate film. As the first exterior sheet and the second exterior sheet, the same kind of material may be used, or different kinds of materials may be used. Surprisingly, also in the case of using different kinds of materials, the curved shape of the battery body can be maintained, and a wrinkle that can be generated on the inner surface of the exterior body can be significantly suppressed by configuration in which the first exterior sheet is thicker than the second exterior sheet.

As the “metal plate”, for example, a plate-like or band-like material made of aluminum, copper, stainless steel (SUS), nickel, or the like can be used without particular limitation.

As for the metal plate, “stainless steel” (SUS) refers to, for example, stainless steel specified in “JIS G 0203 Glossary of terms used in iron and steel”, and may be alloy steel containing chromium or containing chromium and nickel.

In the present disclosure, the “plate shape” means the shape of a structure having two main surfaces parallel or substantially parallel.

In the present disclosure, the “band shape” means the shape of a structure having two main surfaces parallel or substantially parallel and having a longitudinal direction and a width direction perpendicular to the longitudinal direction.

The metal plate can be electrically connected to the positive electrode or the negative electrode of the electrode assembly. In this case, the metal plate can function as a positive electrode terminal or a negative electrode terminal, and can eliminate the presence of a positive electrode lead and/or a negative electrode lead described in detail below. The positive electrode lead or the negative electrode lead may be eliminated.

The metal plate generally has a thickness of 0.3 mm or less, for example, 0.01 mm or more and 0.250 mm or less.

In the present disclosure, the “clad material” means a member formed by simultaneously rolling and joining a plurality of metal materials.

The clad material may include, for example, at least two kinds of metal materials selected from the group consisting of aluminum, tin, copper, invar (alloy), stainless steel (SUS), and nickel. For example, a clad material such as tin/copper (two layers), nickel/copper (two layers), nickel/copper/nickel (three layers), or copper/invar/copper (three layers) can be used.

The clad material can be electrically connected to the positive electrode or the negative electrode of the electrode assembly. In this case, the clad material can function as a positive electrode terminal or a negative electrode terminal, and can eliminate the presence of a positive electrode lead and/or a negative electrode lead described in detail below. The positive electrode lead or the negative electrode lead may be eliminated.

The clad material generally has a total thickness of 0.3 mm or less, for example, 0.01 mm or more and 0.250 mm or less.

The “laminate film” generally means a laminate structure. As the laminate film, a laminate film can be used that includes at least an adhesive layer (innermost layer), a barrier layer (metal foil), and a protective layer (outermost layer) from the innermost layer side toward the outermost layer side. An adhesive material layer may be interposed between the adhesive layer (innermost layer) and the barrier layer (metal foil) and/or between the barrier layer (metal foil) and the protective layer (outermost layer). At least one of the adhesive layer (innermost layer) or the protective layer (outermost layer) can include a resin sheet (that is, a resin layer). Alternatively, at least one of the adhesive layer (innermost layer) or the protective layer (outermost layer) can include a material obtained by applying a solvent to the barrier layer (metal foil) and solidifying the solvent.

The laminate film generally has a total thickness of 0.3 mm or less, for example, 0.06 mm or more and 0.30 mm or less.

In the present disclosure, by using an exterior body including a material as described above, the curved shape of the battery body can be maintained, and a wrinkle that can be generated on the inner surface of the exterior body can be significantly suppressed by configuration in which the first exterior sheet is thicker than the second exterior sheet.

In the present disclosure, the “resin member” means a member that can include a resin material or an elastomer material in a broad sense, and means a member that can include a resin material or an elastomer material having an “insulating property” in a narrow sense. The resin member preferably has not only an “insulating property” but also a “heat sealing property” (or heat adhesiveness).

In the present disclosure, the “insulating property” means an electrical insulating property in a broad sense, and in a narrow sense, means an insulating property such that an electrical short circuit can be prevented in the electrode assembly, particularly between the positive electrode and the negative electrode.

In the present disclosure, the “heat sealing property” generally means a property that exhibits adhesiveness by heating.

As the resin member, a thermoplastic resin, preferably a heat-sealable resin can be used. Examples of the thermoplastic resin include a polyolefin-based resins such as polyethylene and/or polypropylene, preferably polypropylene and copolymers of polypropylene. As the resin member, a single-layer film of a thermoplastic resin or a multilayer film containing a thermoplastic resin can be used. Examples of the multilayer film include a multilayer heat-sealable film in which both surfaces of a high-melting-point resin layer as an intermediate layer are sandwiched between low-melting-point resin layers (thermoplastic resin layers).

Examples of the elastomer material include polyester-based thermoplastic elastomers.

Viewed from another aspect, the resin member may contain a component of an adhesive material that exhibits an insulating property. Examples of such an adhesive material include an acrylic-based adhesive materials such as acrylic acid ester copolymers, rubber-based adhesive materials such as natural rubber, silicone-based adhesive materials such as silicone rubber, urethane-based adhesive materials such as a urethane resin, α-olefin-based adhesive materials, ether-based adhesive materials, an ethylene-vinyl acetate resin-based adhesive materials, epoxy resin-based adhesive materials, vinyl chloride resin-based adhesive materials, chloroprene rubber-based adhesive materials, cyanoacrylate-based adhesive materials, aqueous polymer-isocyanate-based adhesive materials, styrene-butadiene rubber-based adhesive materials, nitrile rubber-based adhesive materials, nitrocellulose-based adhesive materials, reactive hot-melt-based adhesive materials, phenol resin-based adhesive materials, modified silicone-based adhesive materials, polyamide resin-based adhesive materials, polyimide-based adhesive materials, polyurethane resin-based adhesive materials, polyolefin resin-based adhesive materials, polyvinyl acetate resin-based adhesive materials, polystyrene resin solvent-based adhesive materials, polyvinyl alcohol-based adhesive materials, polyvinyl pyrrolidone resin-based adhesive materials, polyvinyl butyral resin-based adhesive materials, polybenzimidazole-based adhesive materials, polymethacrylate resin-based adhesive materials, melamine resin-based adhesive materials, urea resin-based adhesive materials, and/or resorcinol-based adhesive materials.

The resin member may have a film form. That is, the resin member may have a membrane form, that is, a thin plate-like form.

For example, as illustrated in FIG. 2, the secondary battery 20 of the present disclosure may have the resin member 23 that can be disposed at least along the peripheral edge of the electrode assembly. The resin member 23 may be positioned between the first exterior sheet 22a and the second exterior sheet 22b. The first exterior sheet 22a and the second exterior sheet 22b may be bonded to each other with the resin member 23 interposed therebetween. With such a configuration, the sealing property of the secondary battery can be further improved. In particular, the sealing property with respect to the electrode assembly can be further improved.

For example, as illustrated in FIGS. 3 and 4, the resin member 23 may include two or more resin sheets.

For example, in the forms illustrated in FIGS. 3 and 4, the resin member 23 may include two resin sheets including the first resin sheet 23a and the second resin sheet 23b. The first resin sheet 23a and the second resin sheet 23b may be bonded to each other at least along the peripheral edge of the electrode assembly 30. The first resin sheet 23a may be bonded to the first exterior sheet 22a, and the second resin sheet 23b may be bonded to the second exterior sheet 22b.

For example, as illustrated in FIG. 4, since the resin member 23 can include two resin sheets including the first resin sheet 23a and the second resin sheet 23b, the battery is manufactured more easily, and the electrode lead described below can be further protected by sandwiching the electrode lead from both sides while imparting an insulating property to the electrode lead.

For example, in the form illustrated in FIG. 4, an opening is provided in the first resin sheet 23a and the second resin sheet 23b to position and dispose the electrode assembly, but such an opening may be present or absent.

The secondary battery of the present disclosure may have a positive electrode lead and/or a negative electrode lead electrically connected to a positive electrode and/or a negative electrode that can be included in the electrode assembly, respectively, as necessary.

In the present disclosure, the “positive electrode lead” and/or the “negative electrode lead” means a conductor that can be electrically connected to the positive electrode and/or the negative electrode that can be included in the electrode assembly. The material contained in such a conductor is not particularly limited, and is, for example, selected from the group consisting of aluminum, copper, stainless steel (SUS), nickel, and the like.

The positive electrode lead and/or the negative electrode lead may be one formed by extending the positive electrode current collector and/or the negative electrode current collector, or may be another member separately produced from the above-described material.

The positive electrode lead and/or the negative electrode lead may be present or absent, and in a case where the positive electrode lead and/or the negative electrode lead is present, the position thereof is not particularly limited. The positive electrode lead or the negative electrode lead may be present.

The shape of the positive electrode lead and/or the negative electrode lead is not particularly limited. From the viewpoint of forming a thin battery, the positive electrode lead and/or the negative electrode lead preferably has a band-like or membrane-like form.

The positive electrode lead and/or the negative electrode lead may be positioned between the first resin sheet and the second resin sheet (see FIGS. 3 and 4).

For example, as schematically illustrated in FIG. 4, the first lead 24 may extend as a positive electrode lead from the positive electrode 31 (more specifically, the positive electrode current collector 31b) of the electrode assembly 30, and the second lead 25 may extend as a negative electrode lead from the negative electrode 32 (more specifically, the negative electrode current collector 32b) of the electrode assembly 30.

For example, as illustrated in FIG. 4, the first lead 24 and the second lead 25 may be positioned between the first resin sheet 23a and the second resin sheet 23b.

In such a sandwich structure, the first lead 24 and the second lead 25 can be supported between the first resin sheet 23a and the second resin sheet 23b, and the airtightness can be maintained.

At least a part of the positive electrode lead and/or the negative electrode lead may be covered with a sealant.

In the present disclosure, the “sealant” means a member that can be provided to cover at least a part of the positive electrode lead and/or the negative electrode lead to prevent moisture such as water vapor from entering the inside of the battery along the positive electrode lead and/or the negative electrode lead. Such a sealant can also physically reinforce the positive electrode lead and/or the negative electrode lead.

From such a viewpoint, at least a part of the sealant is preferably positioned inside the resin member, particularly between the first resin sheet and the second resin sheet.

The sealant can include, for example, a resin or an elastomer, and the material of the sealant is not particularly limited. Furthermore, the shape is not particularly limited.

From the viewpoint of forming a thin battery, the sealant preferably has a band-like or membrane-like form.

For example, as schematically illustrated in FIG. 4, the first lead 24 as a positive electrode lead may be provided with a first sealant 26, and the second lead 25 as a negative electrode lead may be provided with a second sealant 27. At least a part of the first sealant 26 and/or the second sealant 27 is sandwiched between the first resin sheet 23a and the second resin sheet 23b, and thus a seal structure or sealing structure can be formed.

The above-described configurations can be appropriately changed or used in combination according to the specification of the secondary battery.

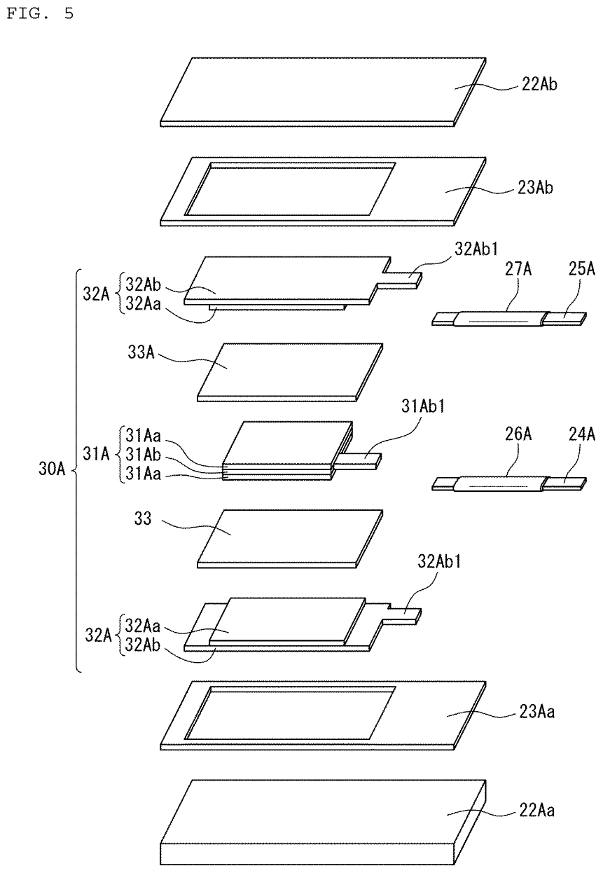

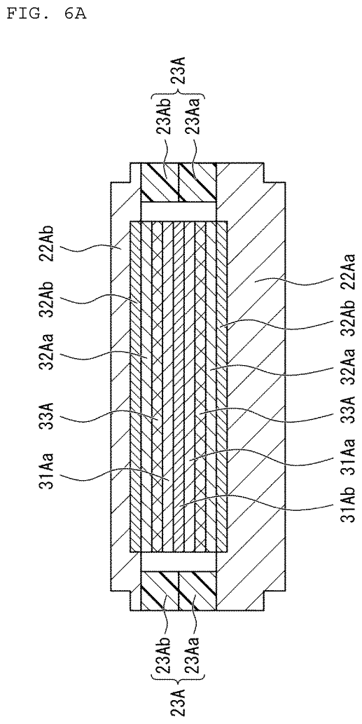

For example, as illustrated in FIGS. 5, 6A, and 6B, the configuration of the electrode assembly that can be included in the secondary battery may be appropriately changed.

An electrode assembly 30A illustrated in FIGS. 5, 6A, and 6B is basically similar to the electrode assembly 30 illustrated in FIG. 4, and includes an additional (or second) positive electrode material layer 31Aa, an additional (or second) separator 33A, and an additional (or second) negative electrode 32A (a negative electrode including an additional (or second) negative electrode material layer 32Aa and an additional (or second) negative electrode current collector 32Ab).

The additional (or second) positive electrode material layer 31Aa may be the same as or different from the positive electrode material layer 31a illustrated in FIG. 4.

The additional (or second) separator 33A may be the same as or different from the separator 33 illustrated in FIG. 4. The additional (or second) negative electrode 32A may be the same as or different from the negative electrode 32 illustrated in FIG. 4. The negative electrode 32A may or may not have a lead 25A and a sealant 27A similar to those illustrated in FIG. 4.

In the secondary battery of the present disclosure, the positive electrode lead 24 may or may not have the sealant 26. In the secondary battery of the present disclosure, the negative electrode lead 25 may or may not have the sealant 27.

In the secondary battery of the present disclosure, each of the first resin sheet 23a and the second resin sheet 23b may or may not have an opening.

The secondary battery of the present disclosure should not be construed as being limited to the above-described embodiments.

Hereinafter, the present disclosure will be described in more detail including with reference to Examples and Comparative Examples according to an embodiment and should not be construed as being limited to the following examples.

### Examples

The following five materials were prepared as exterior sheets used in Examples and Comparative Examples.
(a) Al laminate film (including protective layer (outermost layer), barrier layer (Al foil), and adhesive layer (innermost layer))
(b) Cu plate
(c) Al plate
(d) SUS plate
(e) Clad material (having two or three layers)

Electrode assemblies having configurations similar to those illustrated in FIGS. 5, 6A, and 6B were prepared as an electrode assembly used in Examples and Comparative Examples (T: 0.3 mm×W: 6.0 mm×L: 45.0 mm).

Positive electrode material layer 31Aa: lithium cobalt oxide (Thickness: 50 μm)

Positive electrode current collector 31Ab: aluminum foil (Thickness: 15 μm)

Positive electrode lead 24A: aluminum Thickness: 80 μm) Separator 33A: polypropylene/polyethylene (Thickness: 30 μm)

Negative electrode material layer 32Aa: graphite (Thickness: 48 μm)

Negative electrode current collector 32Ab: copper foil (Thickness: 12 μm)

Negative electrode lead 25A: nickel (Thickness: 80 μm)

Resin sheets having shapes illustrated in FIGS. 5, 6A, and 6B were prepared as a resin member used in Examples and Comparative Examples (T: 0.1 mm x W: 10.0 mm x L: 50.0 mm).

First resin sheet 23Aa: polyolefin-based resin (extending in longitudinal direction along negative electrode lead 25A) (without opening)

Second resin sheet 23Ab: polyolefin-based resin (extending in longitudinal direction along positive electrode lead 24A)

The positive electrode sealant 26A and the negative electrode sealant 27A illustrated in FIG. 5 were omitted.

### Examples 1 to 16

The material of the exterior body was selected from (a) an Al laminate film and (b) a Cu plate, the same material was used in the first exterior sheet 22Aa and the second exterior sheet 22Ab, the thickness of the first exterior sheet 22Aa was set to be larger than the thickness of the second exterior sheet 22Ab, and such an exterior body was used to produce a secondary battery shown in Table 1 below.

The battery body 21 was curved using a round bar (rod 200) having a radius of 10 mm (15 N, 5 seconds, radius of curvature: 10 mm) (see FIGS. 7A to 7D). In the schematic view of FIG. 7A, an aspect is shown in which the longitudinal dimension of the battery body and the circumferential length of the rod 200 are substantially the same, but in these Examples, specifically, the battery body 21 was used that had a longitudinal dimension of about ¾ of the circumferential length of the rod 200.

A wrinkle that was possibly generated on the inner surface of the curved battery body was visually observed.

### [Evaluation]

⊚: A wrinkle is absent
x: A wrinkle is present

The results are shown in Table 1 below.

TABLE 1
Secondary batteries of Examples 1 to 16

| | Exterior body | | | |
|---|---|---|---|---|
| | | Thickness of | Thickness of | |
| | | first exterior | second exterior | |
| | | sheet (inner | sheet (outer | |
| Example | Material | side) (μm) | side) (μm) | Evaluation |
| 1 | Al laminate film | 75 | 60 | [symbol] |
| 2 | Al laminate film | 100 | 60 | [symbol] |
| 3 | Al laminate film | 150 | 60 | [symbol] |
| 4 | Al laminate film | 150 | 100 | [symbol] |
| 5 | Al laminate film | 100 | 75 | [symbol] |
| 6 | Al laminate film | 200 | 60 | [symbol] |
| 7 | Al laminate film | 200 | 100 | [symbol] |
| 8 | Al laminate film | 300 | 60 | [symbol] |
| 9 | Al laminate film | 300 | 200 | [symbol] |
| 10 | Cu plate | 40 | 10 | [symbol] |
| 11 | Cu plate | 50 | 10 | [symbol] |
| 12 | Cu plate | 50 | 20 | [symbol] |
| 13 | Cu plate | 50 | 30 | [symbol] |
| 14 | Cu plate | 100 | 10 | [symbol] |
| 15 | Cu plate | 100 | 50 | [symbol] |
| 16 | Cu plate | 100 | 90 | [symbol] |

In the secondary batteries of Examples 1 to 16, surprisingly, formation of a wrinkle was suppressed due to the fact that the thickness of the first exterior sheet 22Aa (inner side) was larger than the thickness of the second exterior sheet 22Ab (outer side), and no wrinkle was visually confirmed in all of Examples 1 to 16. Furthermore, also in a case where the radius of curvature was 10 mm, the shape was maintained.

### Comparative Examples 1 to 16

Secondary batteries of Comparative Examples 1 to 16 shown in Table 2 below were produced in the same manner as in the above-described Examples except that the thickness of the first exterior sheet 22Aa and the thickness of the second exterior sheet 22Ab were set to be the same or the thickness of the first exterior sheet 22Aa was set to be smaller than the thickness of the second exterior sheet 22Ab.

Each battery body was curved in the same manner as described above, and then a wrinkle that was possibly generated on the inner surface of the battery body was evaluated. The results are shown in Table 2 below.

TABLE 2
Secondary batteries of Comparative Examples 1 to 16

| | Exterior body | | | |
|---|---|---|---|---|
| | | Thickness of | Thickness of | |
| Com- | | first exterior | second exterior | |
| parative | | sheet (inner | sheet (outer | |
| Example | Material | side) (μm) | side) (μm) | Evaluation |
| 1 | Al laminate film | 60 | 60 | X |
| 2 | Al laminate film | 60 | 100 | X |
| 3 | Al laminate film | 60 | 150 | X |
| 4 | Al laminate film | 100 | 100 | X |
| 5 | Al laminate film | 100 | 150 | X |
| 6 | Al laminate film | 150 | 150 | X |
| 7 | Cu plate | 10 | 10 | X |
| 8 | Cu plate | 10 | 20 | X |
| 9 | Cu plate | 10 | 30 | X |
| 10 | Cu plate | 10 | 50 | X |
| 11 | Cu plate | 20 | 20 | X |
| 12 | Cu plate | 20 | 30 | X |
| 13 | Cu plate | 20 | 50 | X |
| 14 | Cu plate | 30 | 30 | X |
| 15 | Cu plate | 30 | 50 | X |
| 16 | Cu plate | 50 | 50 | X |

In the secondary batteries of Comparative Examples 1 to 16, surprisingly, a remarkable wrinkle was formed due to the fact that the thickness of the first exterior sheet 22Aa (inner side) was smaller than or the same as the thickness of the second exterior sheet 22Ab (outer side), and a wrinkle was visually confirmed in all of Comparative Examples 1 to 16. It is considered that the formation of such a wrinkle damages the electrode assembly and thus the battery performance deteriorates.

### Examples 17 to 36

The material of the exterior body was selected from (a) an Al laminate film, (b) a Cu plate, (c) an Al plate, (d) a SUS plate, and (e) a clad material, different materials were used in the first exterior sheet 22Aa and the second exterior sheet 22Ab, the thickness of the first exterior sheet 22Aa was set to be larger than the thickness of the second exterior sheet 22Ab, and such an exterior body was used to produce a secondary battery shown in Table 3 below.

Each battery body was curved in the same manner as described above, and then a wrinkle that was possibly generated on the inner surface of the battery body was evaluated. The results are shown in Table 3 below.

TABLE 3
Secondary batteries of Examples 17 to 36

| | Exterior body | | | | |
|---|---|---|---|---|---|
| | First exterior sheet | | Second exterior sheet | | |
| | (inner side) | | (outer side) | | |
| | | Thick- | | Thick- | |
| | | ness | | ness | |
| Example | Material | (μm) | Material | (μm) | Evaluation |
| 17 | Al laminate film | 60 | Cu plate | 10 | [symbol] |
| 18 | Al laminate film | 100 | Cu plate | 10 | [symbol] |
| 19 | Al laminate film | 100 | Cu plate | 20 | [symbol] |
| 20 | Al laminate film | 200 | Cu plate | 10 | [symbol] |
| 21 | Al laminate film | 200 | Cu plate | 20 | [symbol] |
| 22 | Al laminate film | 200 | Cu plate | 40 | [symbol] |
| 23 | Cu plate | 100 | Al laminate film | 60 | [symbol] |
| 24 | Cu plate | 100 | Al laminate film | 75 | [symbol] |
| 25 | Cu plate | 30 | Al plate | 15 | [symbol] |
| 26 | Cu plate | 50 | Al plate | 30 | [symbol] |
| 27 | Al plate | 30 | Cu plate | 10 | [symbol] |
| 28 | Al plate | 50 | Cu plate | 10 | [symbol] |
| 29 | Cu plate | 30 | SUS plate | 10 | [symbol] |
| 30 | Cu plate | 50 | SUS plate | 10 | [symbol] |
| 31 | SUS plate | 30 | Cu plate | 10 | [symbol] |
| 32 | SUS plate | 50 | Cu plate | 10 | [symbol] |
| 33 | Cu plate | 50 | Clad material | 30 | [symbol] |
| 34 | Cu plate | 100 | Clad material | 30 | [symbol] |
| 35 | Clad material | 50 | Cu plate | 10 | [symbol] |
| 36 | Clad material | 50 | Cu plate | 30 | [symbol] |

In the secondary batteries of Examples 17 to 36, surprisingly, formation of a wrinkle was suppressed due to the fact that the thickness of the first exterior sheet 22Aa (inner side) was larger than the thickness of the second exterior sheet 22Ab (outer side) also in the case of using different materials, in other words, without dependence on the materials, and no wrinkle was visually confirmed in all of Examples 17 to 36. Furthermore, also in a case where the radius of curvature was 10 mm, the shape was maintained.

### Comparative Examples 17 to 38

Secondary batteries of Comparative Examples 17 to 38 shown in Table 4 below were produced in the same manner as in the above-described Examples except that the thickness of the first exterior sheet 22Aa and the thickness of the second exterior sheet 22Ab were set to be the same or the thickness of the first exterior sheet 22Aa was set to be smaller than the thickness of the second exterior sheet 22Ab.

Each battery body was curved in the same manner as described above, and then a wrinkle that was possibly generated on the inner surface of the battery body was evaluated. The results are shown in Table 4 below.

TABLE 4
Secondary batteries of Comparative Examples 17 to 38

| | Exterior body | | | | |
|---|---|---|---|---|---|
| | First exterior sheet | | Second exterior sheet | | |
| | (inner side) | | (outer side) | | |
| Com- | | Thick- | | Thick- | |
| parative | | ness | | ness | |
| Example | Material | (μm) | Material | (μm) | Evaluation |
| 17 | Al laminate film | 60 | Cu plate | 100 | X |
| 18 | Al laminate film | 100 | Cu plate | 100 | X |
| 19 | Cu plate | 10 | Al laminate film | 60 | X |
| 20 | Cu plate | 10 | Al laminate film | 100 | X |
| 21 | Cu plate | 100 | Al laminate film | 100 | X |
| 22 | Cu plate | 10 | Al plate | 15 | X |
| 23 | Cu plate | 10 | Al plate | 30 | X |
| 24 | Cu plate | 30 | Al plate | 30 | X |
| 25 | Al plate | 15 | Cu plate | 30 | X |
| 26 | Al plate | 30 | Cu plate | 30 | X |
| 27 | Cu plate | 10 | SUS plate | 10 | X |
| 28 | Cu plate | 10 | SUS plate | 30 | X |
| 29 | Cu plate | 30 | SUS plate | 30 | X |
| 30 | SUS plate | 10 | Cu plate | 10 | X |
| 31 | SUS plate | 10 | Cu plate | 30 | X |
| 32 | SUS plate | 30 | Cu plate | 30 | X |
| 33 | Cu plate | 30 | Clad material | 30 | X |
| 34 | Cu plate | 30 | Clad material | 50 | X |
| 35 | Cu plate | 50 | Clad material | 50 | X |
| 36 | Clad material | 30 | Cu plate | 30 | X |
| 37 | Clad material | 30 | Cu plate | 50 | X |
| 38 | Clad material | 50 | Cu plate | 50 | X |

In the secondary batteries of Comparative Examples 17 to 38, surprisingly, a remarkable wrinkle was formed due to the fact that the thickness of the first exterior sheet 22Aa (inner side) was smaller than or the same as the thickness of the second exterior sheet 22Ab (outer side), and a wrinkle was visually confirmed in all of Comparative Examples 17 to 38. It is considered that the formation of such a wrinkle damages the electrode assembly and thus the battery performance deteriorates.

The present disclosure relates to the following aspects according to an embodiment.

<1>

A secondary battery including:
an electrode assembly including at least one electrode constituting layer that is layered, the at least one electrode constituting layer each including a positive electrode, a negative electrode, and a separator; and
an exterior body covering the electrode assembly,
the exterior body including two exterior sheets including a first exterior sheet and a second exterior sheet,
the electrode assembly disposed between the first exterior sheet and the second exterior sheet,
the first exterior sheet having a thickness larger than a thickness of the second exterior sheet,
the secondary battery having a curved shape in which the first exterior sheet is disposed inside and the second exterior sheet is disposed outside.
   <2>

The secondary battery according to <1>, wherein a ratio of the thickness of the first exterior sheet to the thickness of the second exterior sheet is 1.1 or more and 25 or less.

<3>

The secondary battery according to <1> or <2>, wherein a difference between the thickness of the first exterior sheet and the thickness of the second exterior sheet is 10 μm or more and 240 μm or less.

<4>

The secondary battery according to any one of <1> to <3>, having a radius of curvature of 5 mm or more when the secondary battery is bent.

<5>

The secondary battery according to any one of <1> to <4>, wherein the first exterior sheet and the second exterior sheet each independently include a metal plate, a clad material, or a laminate film.

<6>

The secondary battery according to any one of <1> to <5>, further including a resin member disposed along a peripheral edge of the electrode assembly, the resin member positioned between the first exterior sheet and the second exterior sheet, the first exterior sheet and the second exterior sheet bonded to each other with the resin member interposed between the first exterior sheet and the second exterior sheet.

<7>

The secondary battery according to <6>, wherein the resin member includes two resin sheets including a first resin sheet and a second resin sheet, the first resin sheet and the second resin sheet are bonded to each other at least along the peripheral edge of the electrode assembly, the first resin sheet is bonded to the first exterior sheet, and the second resin sheet is bonded to the second exterior sheet.

<8>

The secondary battery according to <7>, further including a positive electrode lead and/or a negative electrode lead electrically connected to the positive electrode and/or the negative electrode included in the electrode assembly, respectively,
the positive electrode lead and/or the negative electrode lead positioned between the first resin sheet and the second resin sheet.
   <9>

The secondary battery according to <8>, wherein at least a part of the positive electrode lead and/or the negative electrode lead is covered with a sealant, and at least a part of the sealant is positioned between the first resin sheet and the second resin sheet.

<10>

The secondary battery according to any one of <1> to <9>, having a plate shape.

<11>

The secondary battery according to any one of <1> to <10>, having a band shape.

<12>

The secondary battery according to <11>, wherein the secondary battery having a curved shape has a curved shape constituting at least a part of a virtual circle in a sectional view in a layering direction.

<13>

The secondary battery according to any one of <1> to <12>, being a battery for a wearable device.

<14>

The secondary battery according to <13>, wherein the wearable device is a smart ring.

### INDUSTRIAL APPLICABILITY

The secondary battery of the present disclosure can be used in various fields where power storage may be assumed. The secondary battery of the present disclosure can be used in the fields of electricity, information, and communication in which electrical and electronic devices and the like are used (for example, the fields of electrical and electronic devices or mobile devices including mobile phones, smart phones, notebook computers, digital cameras, activity meters, arm computers, electronic papers, and wearable devices (smartwatches, smart rings, smart glasses), and small electronic machines such as RFID tags, card type electronic money), home and small industrial applications (for example, the fields of electric tools, golf carts, and robots for home, nursing, and industry), large industrial applications (for example, the fields of forklifts, elevators, and harbor cranes), transportation system fields (for example, the fields of hybrid automobiles, electric automobiles, buses, trains, power-assisted bicycles, and electric two-wheeled vehicles), power system applications (for example, the fields of various types of power generation, road conditioners, smart grids, and household power storage systems), medical applications (medical device fields such as earphone hearing aids), pharmaceutical applications (the fields of dosage management systems and the like), IoT fields, space and deep sea applications (for example, the fields of space probes and submersibles), and the like, as merely an example.

### DESCRIPTION OF REFERENCE SYMBOLS

1, 31, 31A: Positive electrode
2, 32, 32A: Negative electrode
3, 33, 33A: Separator
5: Electrode constituting layer
10, 30, 30A: Electrode assembly
20: Secondary battery
21: Battery body
22: Exterior body
22a, 22Aa: First exterior sheet
22b, 22Ab: Second exterior sheet
23, 23A: Resin member
23a, 23Aa: First resin sheet
23b, 23Ab: Second resin sheet
24, 24A: First lead
25, 25A: Second lead
26, 26A: First sealant
27, 27A: Second sealant
31a, 31Aa: Positive electrode material layer
31b, 31Ab: Positive electrode current collector
31b1, 31Ab1: Positive electrode tab
32a, 32Aa: Negative electrode material layer
32b, 32Ab: Negative electrode current collector
32b1, 32Ab1: Negative electrode tab
100′: conventional secondary battery
101′: Body portion
102′: Positive electrode lead
103′: Negative electrode lead
104′: Positive electrode sealant
105′: Negative electrode sealant
200, 200′: Rod

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode assembly including at least one electrode layer that is layered, the at least one electrode layer each including a positive electrode, a negative electrode, and a separator; and
an exterior body covering the electrode assembly,
the exterior body including two exterior sheets including a first exterior sheet and a second exterior sheet,
the electrode assembly disposed between the first exterior sheet and the second exterior sheet,
the first exterior sheet having a thickness larger than a thickness of the second exterior sheet,
the secondary battery having a curved shape in which the first exterior sheet is disposed inside and the second exterior sheet is disposed outside.

2. The secondary battery according to claim 1, wherein a ratio of the thickness of the first exterior sheet to the thickness of the second exterior sheet is 1.1 or more and 25 or less.

3. The secondary battery according to claim 1, wherein a difference between the thickness of the first exterior sheet and the thickness of the second exterior sheet is 10 μm or more and 240 μm or less.

4. The secondary battery according to claim 1, having a radius of curvature of 5 mm or more when the secondary battery is bent.

5. The secondary battery according to claim 1, wherein the first exterior sheet and the second exterior sheet each independently include a metal plate, a clad material, or a laminate film.

6. The secondary battery according to claim 1, further comprising a resin member disposed along a peripheral edge of the electrode assembly, the resin member positioned between the first exterior sheet and the second exterior sheet, the first exterior sheet and the second exterior sheet bonded to each other with the resin member interposed between the first exterior sheet and the second exterior sheet.

7. The secondary battery according to claim 6, wherein the resin member includes two resin sheets including a first resin sheet and a second resin sheet, the first resin sheet and the second resin sheet are bonded to each other at least along the peripheral edge of the electrode assembly, the first resin sheet is bonded to the first exterior sheet, and the second resin sheet is bonded to the second exterior sheet.

8. The secondary battery according to claim 7, further comprising at least one of a positive electrode lead or a negative electrode lead electrically connected to the positive electrode or the negative electrode included in the electrode assembly, respectively,
the at least one of the positive electrode lead or the negative electrode lead positioned between the first resin sheet and the second resin sheet.

9. The secondary battery according to claim 8, wherein at least a part of the at least one of the positive electrode lead or the negative electrode lead is covered with a sealant, and at least a part of the sealant is positioned between the first resin sheet and the second resin sheet.

10. The secondary battery according to claim 1, having a plate shape.

11. The secondary battery according to claim 1, having a band shape.

12. The secondary battery according to claim 11, wherein the secondary battery having a curved shape has a curved shape constituting at least a part of a virtual circle in a sectional view in a layering direction.

13. The secondary battery according to claim 1, being a battery for a wearable device.

14. The secondary battery according to claim 13, wherein the wearable device is a smart ring.
